(19) United States
(12) Patent Application Publication
(10) Pub. No.: US 2005/0125243 A1
(43) Pub. Date: Jun. 9, 2005

(54) Electric power shuttling and management system, and method

(76) Inventor: Victor M. Villalobos, Marietta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/730,848

(22) Filed: Dec. 9, 2003

(51) Int. Cl. G06F 17/60

(52) U.S. Cl. 705/1

(57) ABSTRACT

A method and apparatus for shuttling, managing, and controlling energy flow between suppliers and users based on bid/ask pricing, wherein individual residential/commercial suppliers are aggregated for the purpose of supply and use, and wherein an electricity transmission utility controls the selection and flow of energy from suppliers to users via a controlling device, such as, for exemplary purposes only, a switch turned on by commands sent over a data net to multiple locations simultaneously.

### TECHNICAL FIELD

The present invention relates generally to an apparatus and method for coordinating energy sources with users, and controlling the supply of energy between sources and users. More particularly, the present invention relates to a method of brokering energy supplies among various supply sources by aggregating individual supply sources and aggregating users such that energy is economically advantageously obtained via brokering through a bid/ask process.

### BACKGROUND OF THE INVENTION

It should be noted that energy is the commodity utilized, wherein power is the ability to deliver energy. They are often utilized to describe the same thing, namely, energy and may be utilized interchangeably herein.

Billions of kilowatts of electric energy are transmitted daily across the United States. Increasing demands for transmission time have created a bottleneck within the energy transmission industry. Unfortunately, current channels of transmission continue to get busier and busier, often resulting in the transmission of power approaching gridlock condition during peak usage daylight hours.

As such, the present bottleneck of power transmission has created a business impediment of major proportions for energy re-sellers located in areas where electrical energy is available, but cannot be delivered to the desired end-users, either because the grid is overburdened and stretched to the maximum during the day, or because of too much competition for the same time window.

In 2001, the National Energy Policy reported that the bottleneck of power transmission is one of the most critical energy problems facing the United States today. The fact that the national power grid is nearly gridlocked adversely affects all parties involved in the use of electrical energy in America. That is, the gridlock affects everyone in the United States, from the end user as a homeowner to the commercial building owner, as well as the entire gamut of U.S. industries and companies that require power to regularly conduct business.

In response thereto, President George W. Bush recently issued Executive Order 13302, requiring expedited implementation of methods to improve transmission of energy as part of President Bush's total energy solution plan. The electrical power grid today is fully utilized during the day, a restriction of time and capacity that occurs primarily due to present power transmission methods, wherein energy must be transmitted exactly and simultaneously with the utilization of energy, during a specific transmitting time window. The closest solution to present power transmission problems is to reconstruct the grid. However, billions of dollars would be required to effectively reconstruct the grid to allow for more wire capacity, the implementation of which would require a great deal of time.

Although, there are various devices and methods available for generating and/or storing energy and providing the generated and/or stored energy to end-users, such method and device disadvantages that render implementation of same highly inefficient and impractical.

For instance, various devices and methods exist for facilitating the purchase of off-peak power and the storage of same for subsequent peak shaving or load levelling usage. Such devices disclose the use of various sources of energy, such as large generation companies, small household generators (wind, solar, etc.), and the storage (via battery, capacitor, flywheel, etc.) of energy supplied therefrom. Other devices and methods lack communication and/or coordination between suppliers and users in order to facilitate matching of supply with demand. Particularly lacking is the aggregation of users and/or suppliers into group sources/users of energy. Additionally, apparently absent from current methods is a system for bidding on energy to be purchased, or asking a selling price for energy to be supplied, wherein the bid and ask prices are matched, and wherein a transmission utility has remote control over switching in of sources.

Some systems apply to the transmission of power from local grids, but do not address the major problems encountered with intergrid transmission; that is, transmission between local grids over a national grid network via intermediate carriers. Moreover, such systems do not address the transmission permits required for intergrid use. Furthermore, such systems would indiscriminately provide energy to the grid, and are, as such, substantially limited in application to the local grid.

Intergrid remote energy transmission requires coordination and permits, wherein such transmission of energy must be scheduled in advance and timed to coincide with power storage. Improper scheduling and/or time results in the grid becoming electrically unbalanced. In its simplest terms, power must be put in and taken out at exactly the same time.

Further, previous methods and devices do not provide for the trading of energy, or the management of the sale of energy and the cash generated thereby, from the point of sale to the point of delivery and collection of funds. Current methods deal primarily with storing energy, and do not address the management and/or coordination of energy transmission, nor the collection of funds.

Still other systems fail to address the problem of interstate transmission permitting and coordination, and by default are limited to local energy transmission only. While such systems do address the purchase and sale of power, they do so through a system based on rules and a database of contract prices. Additionally, such systems do not provide for the managing of a purchase/sale based on a bid/ask process, nor do they address the collection of cash. Furthermore, such systems fail to address the purchase of energy from providers in remote locations at an advantageous rate for subsequent sale/use in higher cost locations.

While some or all of the above-referenced devices and methods may well be utilized for storage of energy for subsequent use, each fail to adequately permit the matching of supplies with demands, and further do not facilitate the optimization of energy supply costs via a brokering bid/ask arrangement.

Therefore, it is readily apparent that there is a need for an energy supply/demand management device and method for optimization of energy costs, and management and control of energy supplies among users, and thus avoiding the above-discussed disadvantages. There is a further need for such a device and method, wherein energy purchased at an advantageous rate via a bid/ask process can be stored for subsequent use, thereby facilitating peak shaving and load levelling, and wherein energy can be fed to an electrical grid upon command by an electrical transmission utility, and/or from individual sources, such as, for exemplary purposes only, windmill generators, solar photovoltaics, previously stored energy and the like.

### BRIEF SUMMARY OF THE INVENTION

Briefly described, in a preferred embodiment, the present invention overcomes the above-mentioned disadvantages and meets the recognized need for such a device by providing a method and apparatus for obtaining energy at a reduced cost from energy supplies purchased at off-peak periods and/or from lower cost regional suppliers. The present apparatus and method further coordinate the supplies with the demands of the end-users based upon a bid/ask methodology. Once pricing is determined, control of the sources switched into the grid to supply the energy is undertaken by a transmission utility.

The present invention overcomes the disadvantages of previous systems and methods by marrying the local power grid to a data net, wherein the present invention synchronizes timing and coordination of delivery of energy via a data net, thereby establishing a protocol for delivery of energy to correspond with utilization of energy. The protocol achieves a balanced transmission, in both time and energy, to suppliers and users simultaneously in an orchestrated and synchronized manner.

The present invention also overcomes the problems of intergrid transmission coordination and permitting, thereby expanding use beyond local energy transmission alone.

The present invention provides a method for utilizing low transmission periods (i.e., nighttime) to transport energy to strategic locations for subsequent provision of energy during peak use periods (i.e., daytime).

The present invention resolves the problem of hundreds of electrical generating and transportation utilities acting as resellers of energy across the United States, wherein the electrical generating and transporting utilities compete heavily everyday for transmission time and permits, and battle to utilize the limited time and availability window for transmission during the daylight hours.

The present invention further addresses marketing and other business aspects of managing and storing large amounts of electrical energy at a large number of locations, such as, for exemplary purposes only, power substations, commercial buildings, plants, residences, office buildings, apartment buildings and other strategic locations in the United States for use at a later time. The invention facilitates a method of managing the transportation of energy to such strategic locations for storage well in advance of its required use. The present invention further manages differing voltages in different portions of the distribution line, wherein voltages typically range from 755,000 volts at the generating station down to 7,000 volts at power substations, down to 120 volts at the user level.

The present invention provides a solution to the problem for Independent Power Providers (IPP) by creating a nighttime opportunity for transporting energy to desired cities in the United States in an opportunity never available before. For the IPP, the present invention represents a major breakthrough by enabling their product (i.e., energy) to be delivered to desired markets across the United States. The present invention further opens an avenue for managing the resale of stored energy for use when most needed in large metropolitan areas such as New York, New Jersey and/or California, thereby creating a more competitive market for electrical energy.

The present invention further resolves one of the primary problems facing the United States, namely making energy available in large metropolitan cities across the United States. The present invention makes current power grids twice as effective by allowing storage of billions of megawatts at strategic locations throughout the United States well in advance of the time it is needed, wherein the stored energy can be utilized upon demand via communication over a data net.

For the end-user, either business-owner or homeowner, the present invention opens opportunities for managing his/her energy costs, and provides a method and management tool via a bid/ask process for entire groups of energy users across America. The present invention further facilitates energy purchases in bulk at much lower cost from lower cost producers in other states, or the like, wherein the energy purchased is automatically transmitted overnight and stored at the users own premises for subsequent use, or for the purpose of reselling to the local grid at a higher price. For the homeowner and/or other power user, it also represents an unique method of managing the sale or trade of homeowner generated electrical energy, produced via solar collection, wind generation or other power generation means.

For the IPP across America, the present invention opens wider avenues to shuttle their product and makes megawatts of energy available to be utilized almost instantaneously when demand for energy exceeds local power production capabilities.

The present invention overcomes the disadvantages of previous systems and methods by providing a bid/ask methodology to manage the transmission of energy between locations, as well as managing the collection of funds. Additionally, the present invention goes beyond storage alone by handling trading between users. The present invention also resolves the issues related to intergrid transmission coordination and permitting of same. Multiple permits may be required depending on the complexity and the multi-supplier aspects of complex transactions.

According to its major aspects and broadly stated, the present invention in its preferred embodiment is an apparatus and method for aggregating energy suppliers and energy users, and for connecting energy suppliers with energy users, by switching of energy supplies to a grid based on commands from a transmission utility, wherein the suppliers and users are selected based on a bid/ask process. In such fashion, the power grid and the data net effectively become a single functioning unit.

More specifically, the present invention is a method for aggregating end-users and/or individual suppliers into groups for the purpose of developing a bid/ask system to develop a contract for energy delivery. Particular to the system is a device at the end-user/individual supplier's location that determines the energy needs/supplies and communicates to power companies, wherein the power companies then control and coordinate the delivery of energy over the local grid, both to and from the end-user/individual supplier.

Accordingly, a feature and advantage of the present invention is its ability to allow advantageous purchase of energy at off-peak rates with storage for subsequent use.

A further feature and advantage of the present invention is its ability to match suppliers and users willing to sell and/or buy at the same price point.

An additional feature and advantage of the present invention is its ability to economize and optimize the cost of energy by balancing demand with lowest cost options.

A feature and advantage of the present invention is that energy supplies from a multitude of sources can be switched and orchestrated into the grid on command from the transmission utility.

A further feature and advantage of the present invention is its ability to balance the supply of energy with the load of energy required by users.

Another feature and advantage of the present invention is the aggregation of small suppliers to provide a group energy source.

Another feature and advantage of the present invention is the aggregation of small users to provide a group energy purchase unit for bulk pricing.

A feature and advantage of the present invention is its ability to provide energy to utility generating companies for utilization at a later time.

A feature and advantage of the present invention is that it provides a method of storing and power transmission, wherein the transmission power grid lines are utilized at night to transmit energy, thereby increasing the transmission capacity of the same lines which are typically primarily used during the day only.

Another feature and advantage of the present invention is its ability for an energy user to be able to directly or indirectly to request or negotiate better rates from a local utility by using night power rates only.

An additional feature and advantage of the present invention is its ability to remedy deficiencies of energy during peak hours by feeding stored energy back into the power grid during a black-out or other energy-need emergency.

A further feature and advantage of the present invention is its ability to work with multiple types of energy sources, such as those produced by small local producers (i.e., wind, solar, and the like), and those from large generation facilities (i.e., oil, coal, nuclear, and the like).

A further feature and advantage of the present invention is that homeowner/building owner producers can sell energy to homeowner/building owner users.

An additional feature and advantage of the present invention is its ability to supply continuous, uninterrupted energy to a building when the building is isolated by electrical storms.

These and other features and advantages of the present invention will become more apparent to one skilled in the art from the following description and claims when read in light of the accompanying drawings.

### BRIEF DESCRIPTION OF THE DRAWINGS

Having thus described the invention in general terms, the present invention will be better understood by reading the Detailed Description of the Preferred and Selected Alternate Embodiments with reference to the accompanying drawing figures, which are not necessarily drawn to scale, and in which like reference numerals denote similar structures and refer to like elements throughout, and in which:

FIG. 1 is a diagram depicting prior art in the field of the present invention;

FIG. 2 is a diagram of power and data communications according to a preferred embodiment of the present invention;

FIG. 3 is a detailed diagram of interrelationships between suppliers and users according to a preferred embodiment of the present invention;

FIG. 4 is a detailed diagram of an individual facility connection to the power supply grid according to a preferred embodiment of the present invention;

FIG. 5 is a detailed diagram of the components of a system according to a preferred embodiment of the present invention;

FIG. 6 is a detailed diagram of the coordinator monitor and control module, and its ancillary components, according to a preferred embodiment of the present invention;

FIG. 7 is a diagram depicting the aggregation of users and/or suppliers according to a preferred embodiment of the present invention;

FIG. 8 is a diagram of the bid/ask protocol for purchase and coordination of energy by a group of users from a power supplier according to a preferred embodiment of the present invention;

FIG. 9 is a diagram of the transmission protocol for energy purchased by a group of users from a provider via a power grid according to a preferred embodiment of the present invention;

FIG. 10 is a diagram of the bid/ask protocol for sale and coordination of energy by a group of users to a local power supplier according to a preferred embodiment of the present invention; and

FIG. 11 is a diagram of the transmission protocol for energy supplied by a group of users to a local power grid according to a preferred embodiment of the present invention.

### DETAILED DESCRIPTION OF THE PREFERRED AND SELECTED ALTERNATE EMBODIMENTS

In describing the preferred and selected alternate embodiments of the present invention, as illustrated in the Figures, specific terminology is employed for the sake of clarity. The invention, however, is not intended to be limited to the specific terminology so selected, and it is to be understood that each specific element includes all technical equivalents that operate in a similar manner to accomplish similar functions.

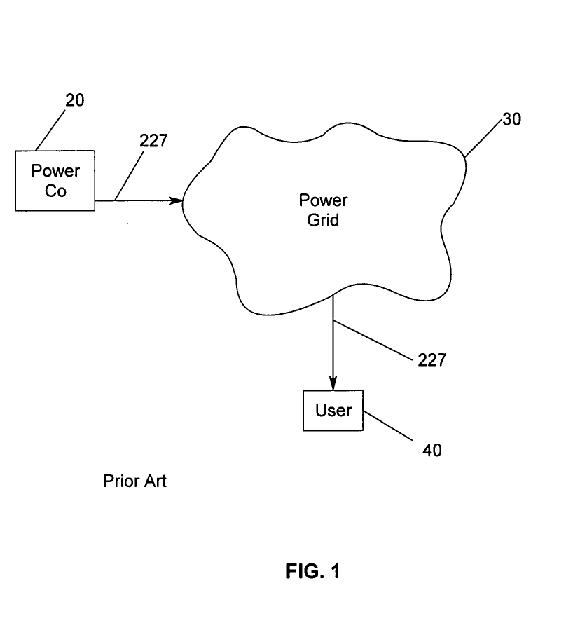

Referring now to FIG. 1, wherein power flow 227 is depicted, represented therein is the current state of the art, wherein local power company 20 is connected to grid 30. Electricity carried by local power company 20 flows into grid 30 and then flows to user 40, wherein user 40 is a residence, office building, plant facility, or the like. User 40 pays a price rate determined by local power company 20, wherein the rate depends upon the time of day and/or the peak level of power utilized. User 40 is unable to obtain a rate that is advantageous because user 40 purchases his energy at the time of use. It would be advantageous if user 40 could purchase power at a time when rates are lower, or from a supplier whose rate is lower, such as, for exemplary purposes only, a supplier remote from the vicinity of user 40. User 40 would then store energy purchased for subsequent use.

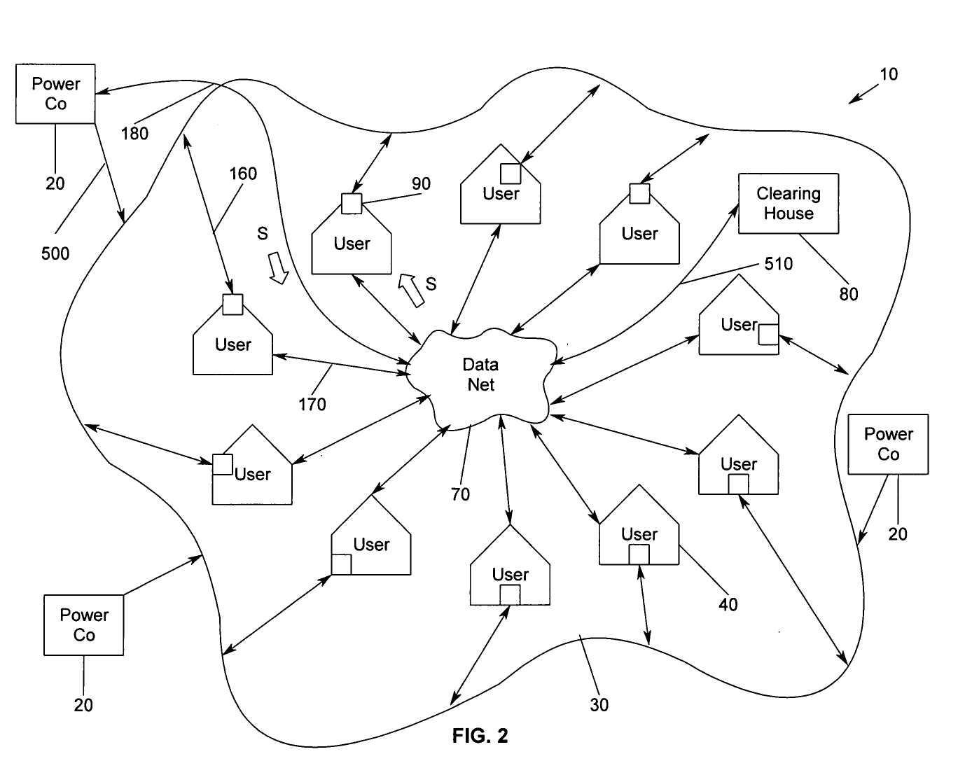

Referring now to FIG. 2, wherein data flow links 170, 180, 510 and energy flow links 160, 500 of the present invention are depicted, data net 70 preferably provides data communication between power company 20 via links 180, users 40 and their associated coordinator monitor and control modules (CMCMs) 90 via links 170, and clearinghouse 80 via link 510. Links 170, 180 and 510 are preferably all bi-directional data transmission connections. Power company 20 is preferably in electrical communication with power grid 30 via uni-directional feed 500, wherein power grid 30 is preferably in electrical communication with users 40 and associated CMCMs 90 via bi-directional power supply connections 160. Power companies 20 preferably provide energy to power grid 30. Power grid 30 preferably supplies energy to users 40. Users 40 preferably post bid/ask pricing on clearinghouse 80. Power companies 20 preferably sell energy to selected user 40 based on the bid price of user 40. Power companies 20 preferably purchase electricity based on the ask price of user 40. When power company 20 wishes to purchase electric energy from user 40, power company 20 preferably sends signal S through communications means, such as, data net 70, wherein signal S preferably activates CMCM 90 located at user 40, wherein CMCM 90 preferably coordinates and synchronizes energy to flow from user 40 to power grid 30.

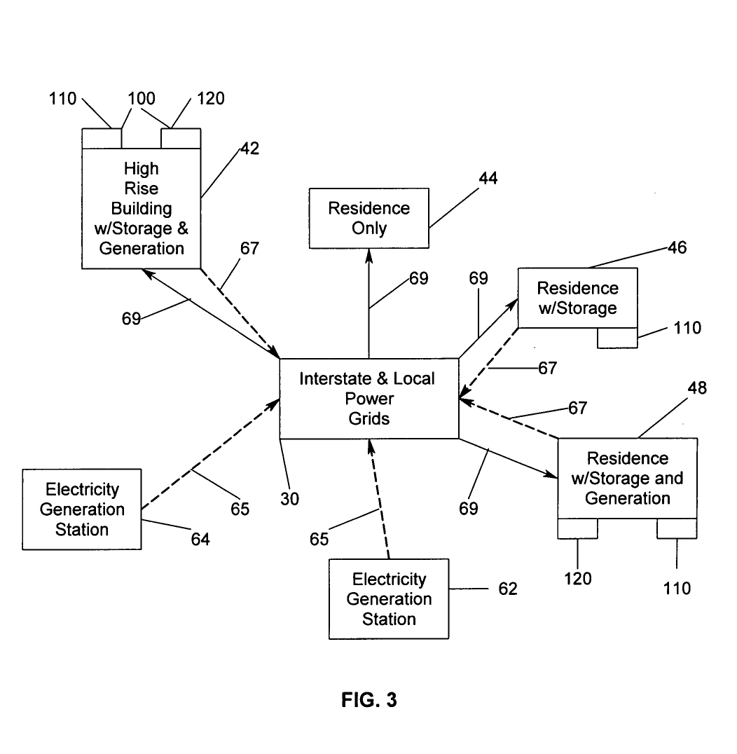

Referring now to FIG. 3, power grid 30 is preferably in electrical communication with high rise building 42, first residence 44, second residence 46, and third residence 48 via grid supply lines 67 and user supply lines 69, first electrical generation station 62 and second electrical generation station 64 via supply lines 65. Grid 30 preferably provides electrical energy from first electrical generation station 62 and second electrical generation station 64, wherein the energy supplied to grid 30 is preferably utilized as required by users, namely, high rise building 42, first residence 44, second residence 46 and third residence 48.

High rise building 42 preferably has multiple power supplementers 100, including both storage devices 110, such as, for exemplary purposes only, batteries, flywheels, capacitors, or the like, and generating devices 120, such as, for exemplary purposes only, wind-powered generators, geothermal-powered generators, solar photovoltaic arrays, fueled generators, or the like.

First residence 44 is preferably a user having no capability to store energy, but who continues to utilize electrical energy provided on grid 30 at the rate applicable to the time period of usage.

Second residence 46 preferably has storage device 110 located therein. Second residence 46 preferably purchases energy from a supplier at an advantageous rate and stores it for later utilization. Second residence 46 preferably sells excess energy back to power grid 30 at an advantageous rate determined by the time sold and/or the user purchasing.

Third residence 48 preferably has generating device 120 and storage device 110, wherein third residence 48 preferably produces energy via generating device 120 and preferably stores energy produced in storage device 110. Third residence 48 preferably utilizes energy from generating device 120 as needed and preferably stores excess energy in storage device 110. During periods when more energy is required than can be produced by generating device 120, third residence 48 preferably draws stored energy from storage device 110. During periods when less energy is required than can be produced by generating device 120, third residence 48 preferably sells excess energy produced from generating device 120 to power grid 30. When excess energy is available in storage device 110, third residence preferably sells such excess energy to power grid 30.

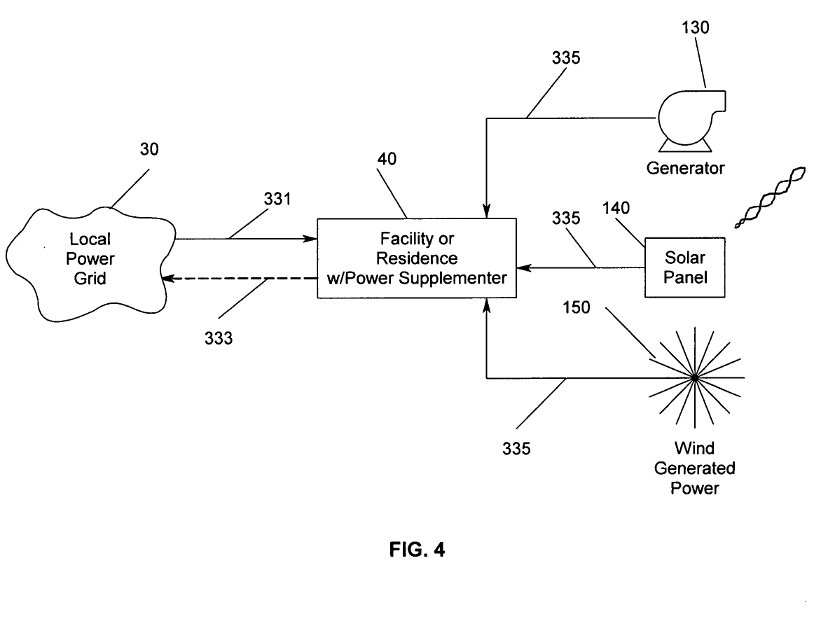

Referring now to FIG. 4, user 40 preferably either buys energy from power grid 30, delivered via path 331 or may sell excess energy to power grid 30, delivered via path 333. If selling energy, user 40 preferably obtains energy via paths 335, wherein such electrical energy has preferably been generated energy via any electrical power generation means, such as, for exemplary purposes only, diesel generator 130, solar photovoltaic panel 140, and/or wind-driven generator 150.

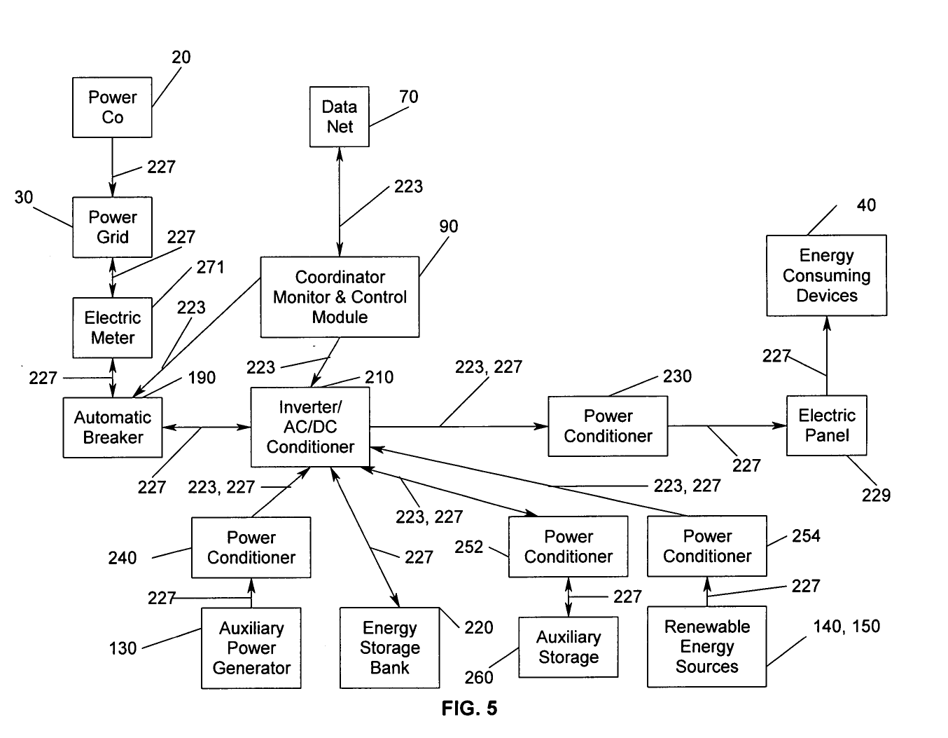

Referring now to FIG. 5, wherein data flow 223 and power flow 227 are depicted, alternating current energy from power company 20 preferably enters residence/business facility of user 40 via automatic breaker 190 and inverter/conditioner 210 preferably controlled by coordinator monitor and control module 90, preferably further flowing to user via power conditioner 230 and electric panel 229. Coordinator monitor and control module 90 preferably receives instructions from data net 70 and preferably permits power to enter facility of user 40 to be consumed. Alternately, upon signal from data net 70, coordinator monitor and control module 90 preferably routes power to automatic breaker 190 for storage of energy. Automatic breaker 190 preferably provides energy to inverter/conditioner 210, wherein inverter/conditioner 210 then preferably supplies direct current to energy storage bank 220. When energy is subsequently needed by facility of user 40, it is preferably drawn from energy storage bank 220 through power conditioner 230, via inverter/conditioner 210, such as, for exemplary purposes only, a sine wave inverter, to preferably provide mains current for facility of user 40. Concurrently, auxiliary alternating current power supply 130, such as, for exemplary purposes only, a diesel or gasoline generator, provides energy to power conditioner 240, wherein power conditioner 240 is preferably directed by CMCM 90 via inverter/conditioner 210 to synchronize phase, voltage, modulation and frequency with power coming via breaker 190, thereby preferably providing synchronized input to inverter/converter 210.

Auxiliary storage 260 preferably provides direct current electricity to first power conditioner/charger 252, wherein first power conditioner/charger 252 preferably converts the voltage of auxiliary storage 260 to a voltage suitable for charging energy storage bank 220, or for use by users 40, or for resale to power grid 30 as synchronized by CMCM 90.

Renewable energy sources, such as for exemplary purposes only, solar 140 or wind energy 150 preferably provide energy to second power conditioner/charger 254, wherein second power conditioner/charger 254 preferably converts voltage of renewable energy sources 140, 150 to a voltage suitable for charging energy storage bank 220, or for use by users 40, or for resale to power grid 30 as synchronized by CMCM 90.

Coordinator monitor and control module 90 preferably receives a command from data net 70 sent by power company 20 and takes action commanded thereby. Coordinator monitor and control module 90 can either permit energy from existing power grid 30 to enter facility of user 40 or it can activate breaker 190 to allow energy, synchronized in phase, voltage, modulation and frequency, to flow to power grid 30 based on command from power company 20. Energy flowing in or flowing out is monitored via electric meter 271.

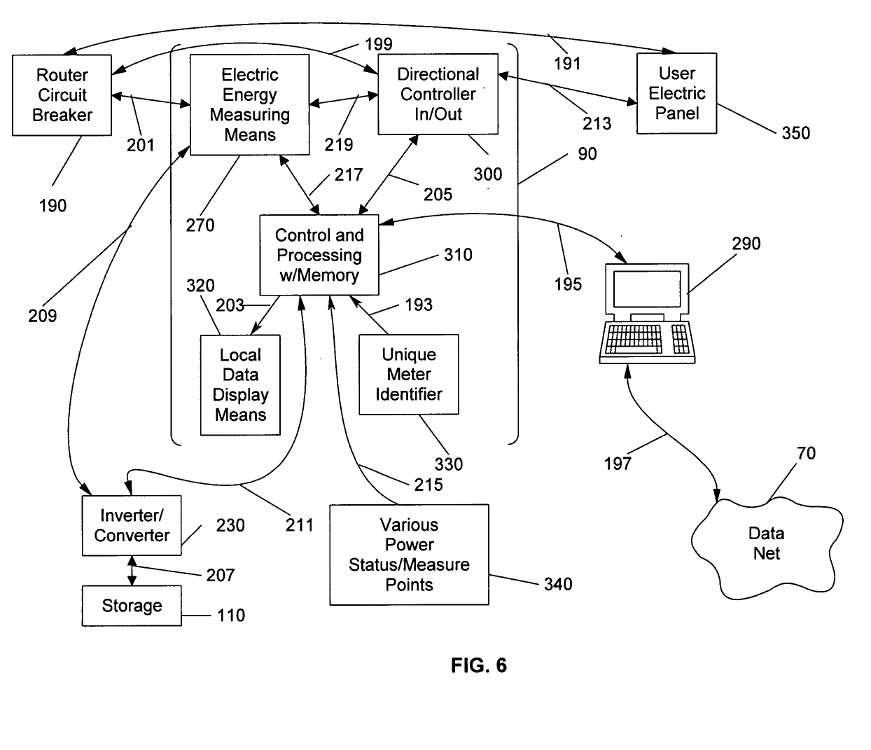

Referring now to FIG. 6, wherein the details of CMCM 90 are depicted along with the interconnections thereto, wherein directional controller 300, processor 310, data display 320, unique meter identifier 330 and electric energy measuring means 270 collectively comprise CMCM 90. Measuring means 270, such as, for exemplary purposes only, a bi-directional meter, is preferably controlled by control processor 310 via path 217, and wherein the direction and quantity of flow of energy through measuring means 270 is preferably monitored by measuring means 270 and is preferably set by directional controller 300 via path 219. Measuring means 270 further preferably connects to router circuit breaker 190 via path 201, wherein router circuit breaker 190 preferably switches the flow of energy in response to commands from directional controller 300 via path 199. Energy flowing to be utilized via router circuit breaker 190 preferably passes via path 191 through to user electric panel 350, wherein the energy is available for utilization by the home or facility owner.

Unique meter identifier 330 preferably provides identification of measuring means 270 to control processor 310 via path 193, wherein control processor 310 preferably communicates via path 195 with computer 290, and wherein computer 290 preferably further communicates via path 197 with data net 70. It will be recognized by those in the art that CMCMs 90 for users 40 could communicate directly via computer 290 to suppliers, such as for exemplary purposes only, power company 20, or with other users 40. Control processor 310 preferably further displays current electrical transmission data via path 203 to local display 320. Unique meter identifier 330 preferably verifies that power transmission data is being transmitted from or to the correct location in order to prevent false orders from being entered and false data from being utilized.

When economic and/or oversupply conditions allow the selling of energy, control processor 310 preferably signals directional controller 300 via path 205 to change router circuit breaker 190 to a condition allowing energy to be sent out. Energy previously stored in storage 110 preferably travels via path 207 and is preferably inverted and conditioned by inverter/converter 230, and is then preferably sold out through energy measuring means 270 via path 209 to router circuit breaker 190. Alternatively, energy from storage 110 can be routed via path 211 through to electric user panel 350 by control processor 310, wherein energy is then sent via path 205, directional controller 300 and path 213 to augment incoming energy arriving via router circuit breaker 190.

Control processor 310 preferably monitors power status measurement points 340 via path 215. Control processor 310 is also preferably programmed to provide a single transmission transaction, or alternately could be programmed to manage a series of scheduled transactions.

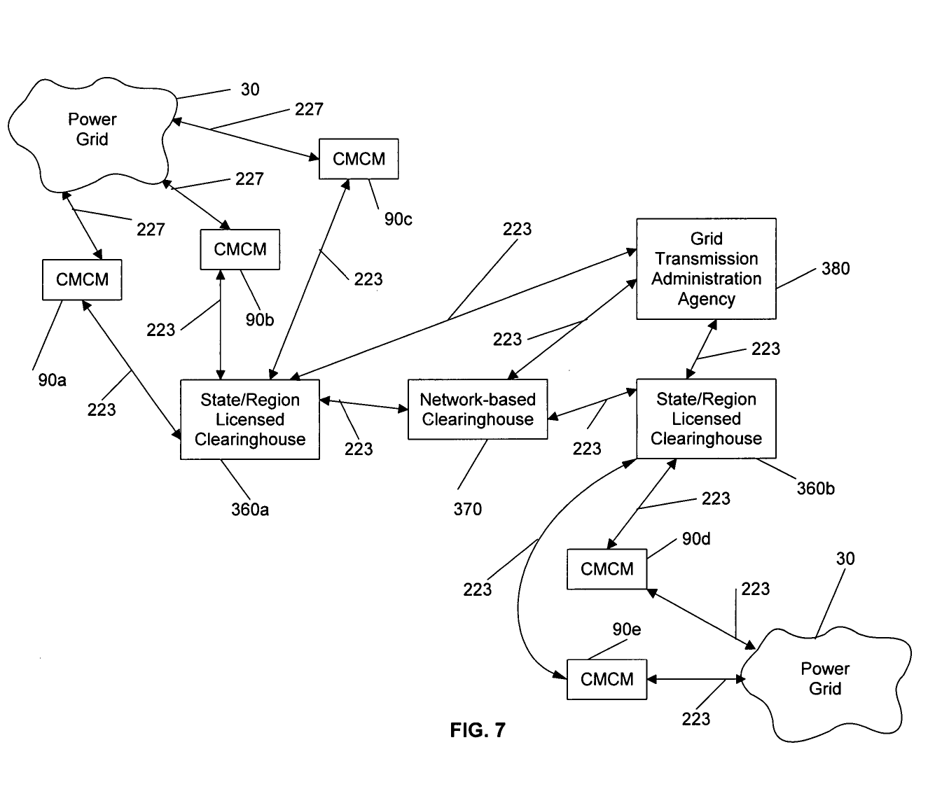

Referring now to FIG. 7, energy from, or to, power grid 30 preferably travels via power flows 227 and is preferably supplied to, or provided by, CMCMs 90a, 90b, 90c, 90d and 90e, wherein data flows 223 are also shown. CMCMs 90a, 90b, 90c, 90d and 90e preferably bid for energy desired, or preferably ask a price for energy user will supply to power grid 30 via user's state or regional clearinghouse 360a, for CMCMs 90a, 90b and 90c, or state or regional clearinghouse 360b for CMCMs 90d and 90e, respectively. The respective clearinghouses 360a and 360b preferably communicate with each other via network based clearinghouse 370, wherein bid and ask prices are preferably matched thereby. Grid transmission agency 380 preferably coordinates transmission to individual CMCMs 90a, 90b, 90c, 90d and 90e and preferably provides permitting therefor.

CMCMs 90a, 90b and 90c preferably combine to form one aggregated user/supplier grouping. CMCMs 90d and 0.90e preferably combine to form another aggregated user/supplier grouping. A group bid or ask price, along with quantities desired or available, is preferably provided to the CMCM's respective clearinghouses 360a and 360b via data net 70, wherein the total aggregated quantity and pricing are preferably matched with available supplies or needs of other groups by network-based clearinghouse 370 and grid transmission agency 380. CMCMs 90 preferably communicate with clearinghouses 360a and 360b to coordinate transmission of energy and also to preferably send/receive transmission diagnostics.

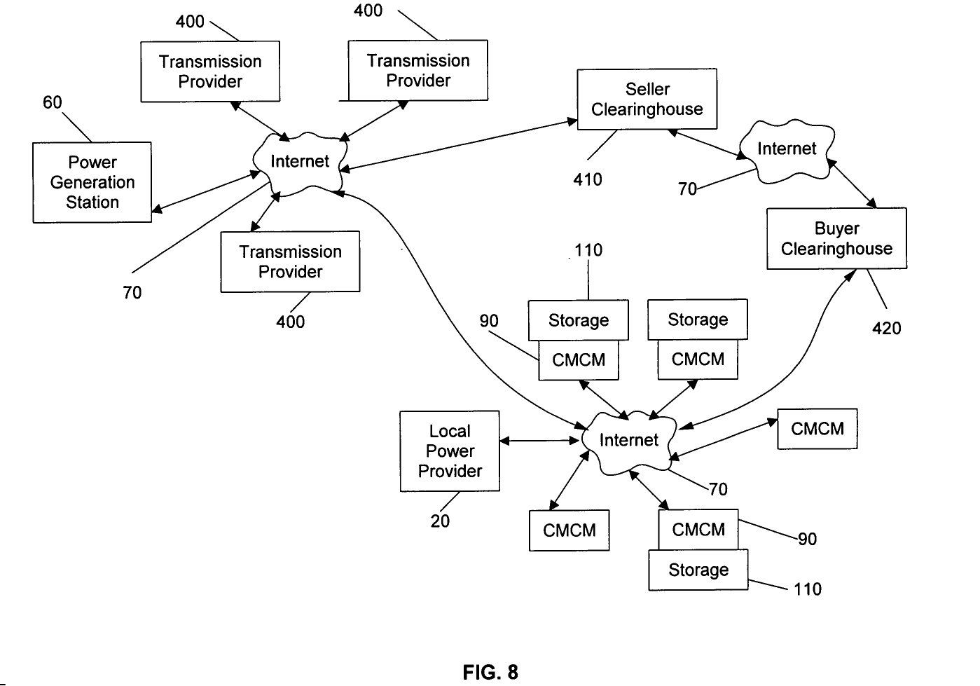

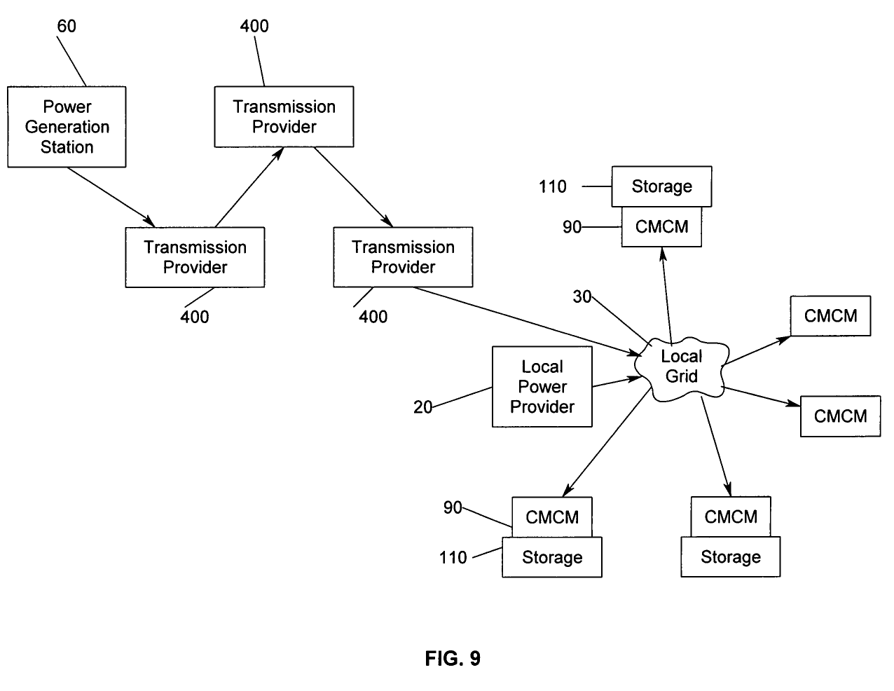

Referring now to FIGS. 8 and 9, wherein energy sale to user aggregates is depicted, and wherein FIG. 8 depicts the communications flow network and FIG. 9 depicts the power flow network for such a sale of energy, an automatic power/energy request and a bid price for energy are preferably sent by CMCM 90 via data net 70 to buyer clearinghouse 420. Buyer clearinghouse 420 preferably aggregates power/energy requests from CMCMs 90 within a specifically-defined user grouping, and/or preferably aggregates CMCMs 90 requiring energy into a user grouping for the purpose of determining energy and power requirements. Buyer clearinghouse 420 preferably posts a bid price for aggregate user grouping, wherein seller clearinghouse 410 preferably compares the bid price with the asking price from energy suppliers 400 and either rejects or accepts the bid. If the bid is accepted, seller clearinghouse 410 preferably schedules power delivery and arranges required permitting, as is required for intergrid transmissions. It will be recognized by those skilled in the art that seller clearinghouse 410 could post the asking prices and buyer clearinghouse 420 could compare bid pricing from user grouping of CMCMs 90 and/or local power provider 20 for matching with the asking prices.

CMCM 90 may purchase energy for subsequent use and/or sale to economize and optimize the cost by balancing demand with lowest cost options, and, in such an event, will send energy purchased to storage 110.

Buyer clearinghouse 420 and seller clearinghouse 410 preferably continuously compare varying bid and ask prices. When a match is found, buyer clearinghouse 420 and seller clearinghouse 410 preferably accept the contract for energy supply and notify CMCMs 90, transmission providers 400, power generation station 60, and local power provider 20 of scheduled time and permit for energy transmission. CMCMs 90 are preferably continuously monitored, wherein the monitoring may be viewed visually, for readiness by buyer clearinghouse 420 until transmission is completed.

Power transmission preferably begins in accordance with the contract, schedule and permits established. In the event of interruption of delivery, buyer clearinghouse 420 preferably restarts delivery. Upon completion of delivery of energy required, funds are preferably collected by buyer clearinghouse 420 from local power provider 20 or user grouping of CMCMs 90. Buyer clearinghouse 420 preferably transfers funds electronically to seller clearinghouse 410, wherein seller clearinghouse 410 preferably issues funds electronically to transmission providers 400 and/or power generation station 60.

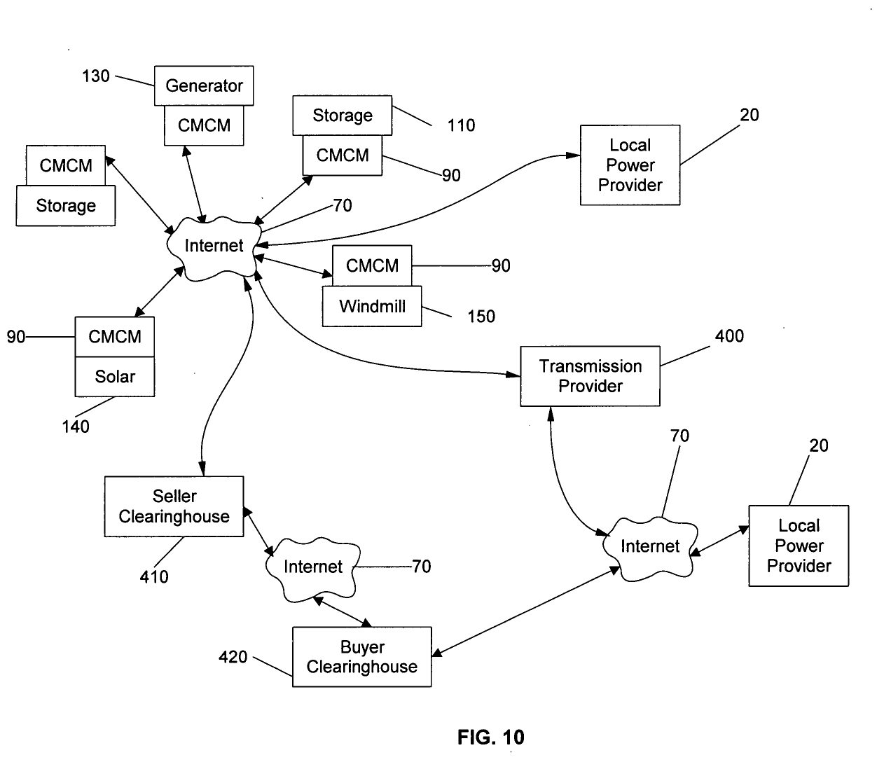

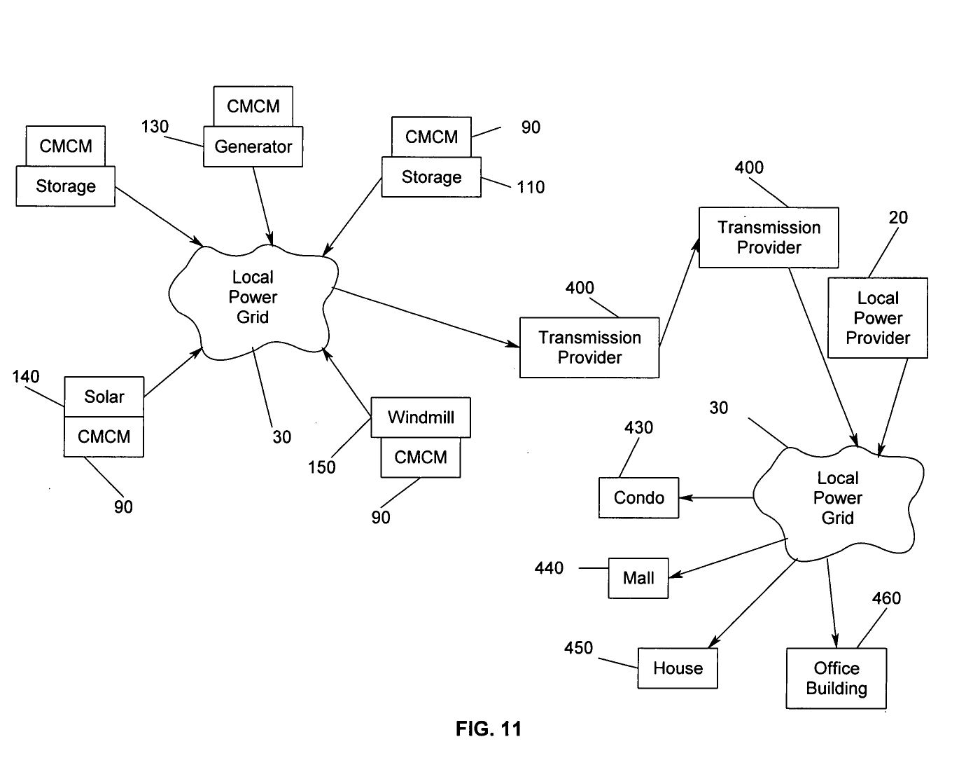

Referring now to FIGS. 10 and 11, wherein FIG. 10 depicts the data communication flow network and FIG. 11 depicts the power flow network, showing suppliers, users, grids and the transmission lines connecting same, a request for electric power is preferably made by local power provider 20 or buyer clearinghouse 420 based on present needs or pre-scheduled requirements, wherein local power provider 20 preferably provides a bid price to buyer clearinghouse 420. CMCMs 90 preferably communicate availability of energy from storage 110, or generation means, such as, for exemplary purposes only, solar photovoltaic or photothermal 140, windmill generator 150 and/or diesel generator 130.

Seller clearinghouse 410 preferably aggregates available individual energy supply quantities and the asking prices as determined by CMCMs 90 via data net 70, and preferably posts the aggregated asking price and quantity available on data net 70.

Buyer clearinghouse 420 preferably matches the bid price with the asking price, wherein a contract for delivery of energy to local power provider 20 is created. Seller clearinghouse 410 preferably schedules time of delivery and obtains permits for transmission over intergrid transmission provider 400, if required, or alternately schedules power delivery to local grid 30a.

Energy is delivered from storage 110, or generation means 130, 140, and/or 150 to local power grid 30a. Local power grid 30a preferably transmits energy via transmission provider 400, to local grid 30b, wherein local power grid 30b preferably provides energy to end-users, such as, for exemplary purposes only, condominium or apartment 430, shopping mall 440, residence 450 and/or office building 460.

Seller clearinghouse 410 preferably monitors CMCMs 90 for readiness, wherein the monitoring may be viewed visually, until transmission is completed and preferably further restarts transmission in the case of interruption. Upon completion of transmission of energy, buyer clearinghouse 420 preferably collects funds from local power provider 20 and issues funds electronically to seller clearinghouse 410. Thereafter, seller clearinghouse 410 preferably electronically distributes funds to CMCMs 90.

In an alternate embodiment of the present invention, clearinghouses 410 and 420 could log bid price and asking price data and transform the data into a report. Such a report could then be utilized for marketing purposes, and/or sold to others for marketing purposes.

It is contemplated in an alternate embodiment of the present invention that storage 110 of energy could take place at an electrical substation.

It is further contemplated in an alternate embodiment of the present invention that user and/or suppliers could be aggregated for purchasing purposes even though they are not on the same local grid, and, in fact, could be hundreds or thousands of miles apart, but aggregated by the common thread of their bid/ask price contract.

It is contemplated in another alternate embodiment that users may obtain their energy directly from suppliers and may communicate directly therebetween.

It is contemplated in still another alternate embodiment that a user could receive a supply of energy from a supplier via multiple different transmission paths.

In yet another alternate embodiment, it is envisioned that delivery of energy could be carried out on a set periodic schedule after a contract is established.

In still another alternate embodiment, it is contemplated that storage of energy could take place at any point along the distribution line from supplier to user, including, but not limited to, storage at supplier locations, storage at electrical substations and storage at user locations.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing the steps of the method in a certain order does not constitute any limitation on the order of the steps of the method. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

1. A method for providing energy comprising the steps of:
a. aggregating at least two suppliers of energy into an economic supplier unit; and
b. supplying energy from said economic supplier unit at a selected price.

2. The method of claim 1, further comprising the step of:
a. associating an asking price for said energy, wherein said economic supplier unit selects said asking price.

3. The method of claim 1, wherein said economic supplier unit stores electrical energy at multiple locations.

4. The method of claim 3, wherein said multiple locations comprise substations, factories, plants, warehouses, office buildings, apartment buildings, building structures and residences.

5. The method of claim 1, wherein said energy is available to utility transmission companies, and wherein said utility transmission companies immediately utilize said energy.

6. The method of claim 5, wherein said utility transmission companies purchase said energy from said economic supplier unit.

7. The method of claim 1, wherein said energy is available to utility transmission companies, and wherein said utility transmission companies store said energy.

8. The method of claim 1, further comprising the step of
c. transmitting said energy into a utility power grid.

9. The method of claim 1, wherein said economic supplier unit collects energy from a utility power grid during low cost periods and stores said energy for utilization at a subsequent time.

10. The method of claim 1, wherein said economic supplier unit generates energy locally via an electrical generation means, and wherein said energy is stored at multiple locations for subsequent use.

11. The method of claim 10, wherein said electrical generation means is selected from the group consisting of generators, solar arrays, windmills and geothermal sources.

12. The method of claim 1, further comprising the step of monitoring the quantity of energy available from said energy supplier unit.

13. A method for utilizing energy comprising the steps of:
a. aggregating at least two users of energy into an economic user unit; and
b. supplying energy to said economic user unit at a selected price.

14. The method of claim 13, further comprising the step of:
a′. associating a bid price for purchase of said energy, wherein said economic user unit selects said bid price.

15. The method of claim 13, wherein said economic user unit stores electrical energy at multiple locations.

16. The method of claim 15, wherein said multiple locations comprise substations, factories, plants, warehouses, office buildings, apartment buildings, building structures and residences.

17. The method of claim 13, wherein said energy is available to utility transmission companies, and wherein said utility transmission companies immediately utilize said energy.

18. The method of claim 17, wherein said utility transmission companies purchase said energy from said economic supplier unit.

19. The method of claim 13, wherein said energy is available to utility transmission companies, and wherein said utility transmission companies store said energy.

20. The method of claim 13, further comprising the step of
c. transmitting said energy into a utility power grid.

21. The method of claim 13, wherein said economic supplier unit collects energy from a utility power grid during low cost periods and stores said energy for utilization at a subsequent time.

22. The method of claim 13, wherein said economic supplier unit generates energy locally via an electrical generation means, and wherein said energy is stored at multiple locations for subsequent use.

23. The method of claim 22, wherein said electrical generation means is selected from the group consisting of generators, solar arrays, windmills and geothermal sources.

24. The method of claim 13, further comprising the step of monitoring the quantity of energy available from said energy supplier unit.

25. A method for supplying energy from at least one supplier to at least one user comprising the steps of:
a. offering an asking price by said at least one supplier;
b. offering a bid price by said at least one user;
c. posting said asking price and said bid price on a data net;
d. matching said asking price and said bid price; and
e. establishing a contract for the supply of a quantity of energy when said bid price and said asking price match.

26. The method of claim 25, further comprising the step of:
f. obtaining permits for the transfer of energy over an electrical grid from said at least one supplier to said at least one user.

27. The method of claim 26, further comprising the step of:
g. transmitting said energy from said at least one supplier to said at least one user via said electrical grid.

28. The method of claim 25, wherein said step of matching said asking price further comprises the step of:
d′. utilizing a clearinghouse.

29. The method of claim 25, further comprising the steps of:
f′. logging activity and accounting data of a plurality of said asking prices and a plurality of said bid prices; and
g′. transforming said logged activity and accounting data into a report.

30. The method of claim 25, further comprising the step of:
f′. marketing data derived from said bid price and said asking price.

31. A method of coordinating and controlling energy sources with energy users via data net comprising the steps of:
a. connecting suppliers of energy to users of energy via electrical supply lines and communications means simultaneously;
b. ascertaining asking price for said energy and quantity of said energy available for each supplier;
c. ascertaining bid price users are willing to pay for said energy;
d. commanding selected suppliers to provide said energy to an electrical grid; and
e. providing selected users with said energy from said suppliers.

32. The method of claim 31, further comprising the step of:
d′. synchronizing the provision of energy to said electrical grid, wherein load and supply are in balance.

33. The method of claim 31, wherein said communications means comprises a data net.

34. The method of claim 31, wherein said energy is purchased, stored and sold, and wherein a purchase price is less than a selling price.

35. The method of claim 31, wherein said energy is stored at different points along a distribution line, and wherein said distribution line comprises grid-to-grid transmission lines.

36. The method of claim 31, wherein said distribution line further comprises suppliers and users.

37. The method of claim 35, wherein said stored energy is delivered to said distribution line synchronized in phase, frequency, voltage and modulation.

38. The method of claim 31, further comprising the steps of:
f. obtaining permits for transmission of said energy; and
g. coordinating protocols for delivery and use of said energy.

39. An apparatus comprising:
at least one coordinating monitoring and control module;
at least one power conditioner;
at least one means for storage;
at least one automatic circuit breaker; and
at least one load.

40. The apparatus of claim 39, wherein said apparatus controls at least one characteristic parameter of said energy selected from the group of phase, frequency, voltage, modulation, and combinations thereof.

41. The apparatus of claim 39, wherein said apparatus collects energy from a utility grid during low cost periods and stores said energy for utilization at a later time.

42. The apparatus of claim 39, wherein said apparatus allows stored energy to be supplemented with energy from secondary energy sources.

43. The apparatus of claim 42, wherein said secondary energy sources comprise at least one source selected from the group consisting of wind-powered generators, fueled generators, geothermal energy and solar photovoltaic energy.

44. The apparatus of claim 39, wherein said apparatus stores electrical energy at multiple locations comprising at least one location selected from the group consisting of residences, factories, plants, warehouses, office buildings and apartment buildings.

45. The apparatus of claim 39, wherein said stored energy is supplied to an electric power grid.

46. A monitoring modular device comprising:
at least one data net;
at least one memory means for storing data;
means for communicating with other monitoring modular devices;
means for displaying data;
means for self-diagnosis; and
security identification code.

47. The monitoring modular device of claim 46, wherein said monitoring modular device coordinates and controls the direction of energy flow between a utility grid and an energy user.

48. The monitoring modular device of claim 46, wherein said monitoring modular device communicates with other monitoring modular devices to facilitate selling and buying energy via a local and/or remote power grid.

49. The monitoring modular device of claim 46, wherein said monitoring modular device further meters said energy flow.

50. The monitoring modular device of claim 46, wherein said monitoring modular device further certifies the quantity of power being transmitted in or out.

51. The monitoring modular device of claim 46, wherein said monitoring modular device is programmed to handle, manage, transmit and condition energy having voltages ranging from 755,000 volts to 120 volts of alternating current.

52. The monitoring modular device of claim 46, wherein said energy flow is scheduled as a single transaction or as a series of repetitive prearranged and/or prescheduled transactions.

53. The monitoring modular device of claim 46, further comprising an unique identification code.

54. The monitoring modular device of claim 46, wherein said monitoring modular device manages and coordinates directional control of the transmission of power.

55. The monitoring modular device of claim 54, wherein said monitoring modular device further monitors status of power transmission.

56. The monitoring modular device of claim 46, wherein said monitoring modular device maintains transactional data.

57. The monitoring modular device of claim 46, wherein said monitoring modular device transmits transactional data.

58. The monitoring modular device of claim 46, wherein said monitoring modular device measures the amount of energy stored in a particular residence or facility for an energy supply transaction.

59. The monitoring modular device of claim 46, wherein said monitoring modular device monitors and controls stored energy and its rate of usage.

60. A method for coordinating the transmission and delivery of energy between providers and users comprising the steps of:
a. providing a signal from a purchaser in need of energy;
b. transmitting said signal to at least one supplier; and
c. delivering said energy.

61. The method of claim 60, wherein the step of delivering said energy comprises delivery of energy via multiple paths.

62. The method of claim 60, wherein said method is automatic.

63. The method of claim 60, further comprising the steps of:
d. coordinating the transfer of funds for purchases of said energy; and
e. documenting said funds transfers.

64. A business method for selling and buying electrical energy from and to multiple locations comprising the steps of:
a. accumulating energy from energy suppliers;
b. storing said energy; and
c. selling said energy over an electrical grid to energy users.

65. The method of claim 64, wherein said energy users have the option to set their own bid price for said energy.

66. The method of claim 64, wherein said energy suppliers have the option to set their own asking price for said energy.

67. The method of claim 64, further comprising the step of:
d. collecting funds electronically for the quantity of energy sold.

68. The method of claim 67, wherein suppliers provide and asking price and users provide a bid price, further comprising the step of:
e. allowing a clearinghouse to match said bid prices with said asking prices.

69. The method of claim 64, wherein said method further comprises the step of:
d′. prearranging at least one schedule for the transmission of energy.

70. The method of claim 68, wherein said prearranged schedule is repetitive or cyclical in nature.

71. The method of claim 66, wherein said energy suppliers have storage batteries, and wherein said storage batteries are recharged during off-peak periods, whereby the energy stored in said storage batteries is sold to utility companies during peak periods.

72. An apparatus for protection of computers or other delicate devices utilizing full sine wave inverters powered by batteries having energy stored therein, wherein said batteries are interposed between said inverters and a power grid, whereby said inverters are isolated from variations at the power grid.

73. A system for reducing power demand comprising:
at least one coordinating monitoring and control module, wherein said at least one coordinating monitoring and control module directs the flow of energy to and from at least one battery, wherein said at least one battery is charged with energy during off-peak energy use periods, and wherein said at least one battery releases its energy during peak energy use periods, whereby the requirement for externally-supplied power during peak periods is reduced.
